(19) United States
(12) Patent Application Publication
(10) Pub. No.: US 2022/0380544 A1
(43) Pub. Date: Dec. 1, 2022

(54) POLYIMIDE COPOLYMER, AND POLYIMIDE FILM AND MANUFACTURING METHOD THEREOF

(71) Applicant: NAN YA PLASTICS CORPORATION, TAIPEI (TW)

(72) Inventors: TE-CHAO LIAO, TAIPEI (TW); SEN-HUANG HSU, TAIPEI (TW); YU-LIN LI, Taoyuan City (TW)

(21) Appl. No.: 17/541,692

(22) Filed: Dec. 3, 2021

(30) Foreign Application Priority Data
May 11, 2021 (TW) 110116857

(51) Int. Cl. C08G 73/10; C09D 179/08

(52) U.S. Cl. CPC C08G 73/1078; C08G 73/1042; C09D 179/08

(57) ABSTRACT

A polyimide copolymer, a polyimide film, and a manufacturing method of the polyimide film are provided. The polyimide copolymer includes a plurality of repeating units represented by a following formula (I) and a plurality of repeating units represented by a following formula (II).

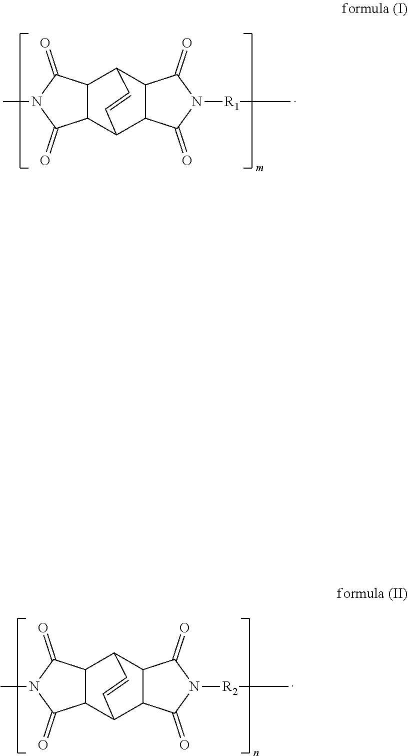

A structural formula of a substituent R₁ is shown as follows:

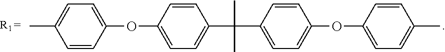

A structural formula of a substituent R₂ is shown as follows:

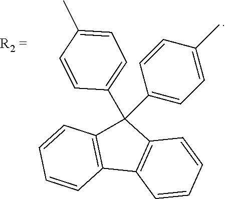 [SMILES: Cc1ccc(C2(c3ccc(C)cc3)c3ccccc3-c3ccccc32)cc1]

In addition, the polyimide copolymer has a weight average molecular weight (Mw) of between 30,000 and 200,000.

### CROSS-REFERENCE TO RELATED PATENT APPLICATION

This application claims the benefit of priority to Taiwan Patent Application No. 110116857, filed on May 11, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyimide copolymer, and more particularly to a polyimide copolymer, a polyimide film, and a manufacturing method of the polyimide film.

### BACKGROUND OF THE DISCLOSURE

Since a conventional polyimide film has light transmittance and flexibility, the conventional polyimide film can be applied to a protective film of a flexible panel, and processing conditions of the polyimide film are suitable for production by a precision coating machine.

However, during a manufacturing process of the conventional polyimide film, a significant period of time is needed to synthesize a polyimide resin under high temperature. When the polyimide resin undergoes synthesis under high temperature for an extended period of time, a yellowing problem is likely to occur thereto.

Furthermore, the conventional polyimide film cannot have high transparency, hardness, flexibility, and toughness at the same time. In other words, in order to increase the hardness of the conventional polyimide film, its transparency or flexibility may be sacrificed.

### SUMMARY OF THE DISCLOSURE

In response to the above-referenced technical inadequacies, the present disclosure provides a polyimide copolymer, a polyimide film, and a manufacturing method of the polyimide film.

In one aspect, the present disclosure provides a polyimide copolymer which includes a plurality of repeating units represented by a following formula (I) and a plurality of repeating units represented by a following formula (II). The plurality of repeating units represented by the following formula (I) and the plurality of repeating units represented by the following formula (II) are configured in a block arrangement or a random arrangement.

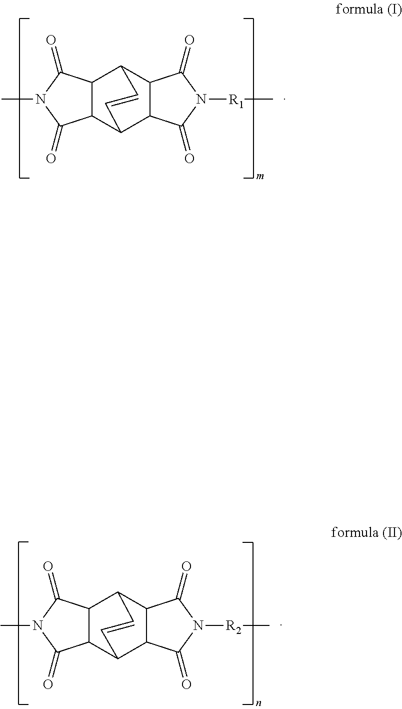

A structural formula of a substituent R₁ is shown as follows:

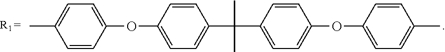

A structural formula of a substituent R₂ is shown as follows:

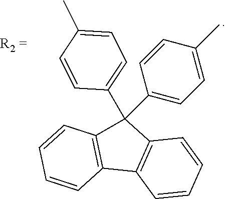 [SMILES: Cc1ccc(C2(c3ccc(C)cc3)c3ccccc3-c3ccccc32)cc1]

In addition, the polyimide copolymer has a weight average molecular weight (Mw) of between 30,000 and 200,000.

In certain embodiments, m represents a number of repetitions of the plurality of repeating units represented by the formula (I) in a molecular structure of the polyimide copolymer, and n represents a number of repetitions of the plurality of repeating units represented by the formula (II) in the molecular structure of the polyimide copolymer, in which 0.1≤n/(m+n)≤0.6, and 0.4≤m/(m+n)≤0.9.

In certain embodiments, 0.2≤n/(m+n)≤0.5, and 0.5≤m/(m+n)≤0.8.

In certain embodiments, R₁ is a residue other than two amino groups (—NH₂) in a first aromatic diamine compound, and the first aromatic diamine compound is 1,1-bis[4-(5-amino-2-pyridyloxy)phenyl]-1-phenylmethane (BAPPm). R₂ is a residue other than two amino groups (—NH₂) in a second aromatic diamine compound, and the second aromatic diamine compound is 9,9-bis(4-aminophenyl)-fluorene (FDA).

In certain embodiments, the polyimide copolymer is formed by performing a poly-condensation reaction between the first aromatic diamine compound (BAPPm) and an alicyclic dianhydride compound, and performing a poly-condensation reaction between the second aromatic diamine compound (FDA) and the alicyclic dianhydride compound. The alicyclic dianhydride compound is bicyclo[2.2.2]oct-7-ene-2,3,5,6-tetracarboxylic dianhydride (B1317).

In another aspect, the present disclosure provides a polyimide film. A composition of the polyimide film includes a polyimide copolymer, and the polyimide copolymer includes a plurality of repeating units represented by a following formula (I) and a plurality of repeating units represented by a following formula (II). The plurality of repeating units represented by the following formula (I) and the plurality of repeating units represented by the following formula (II) are configured in a block arrangement or a random arrangement.

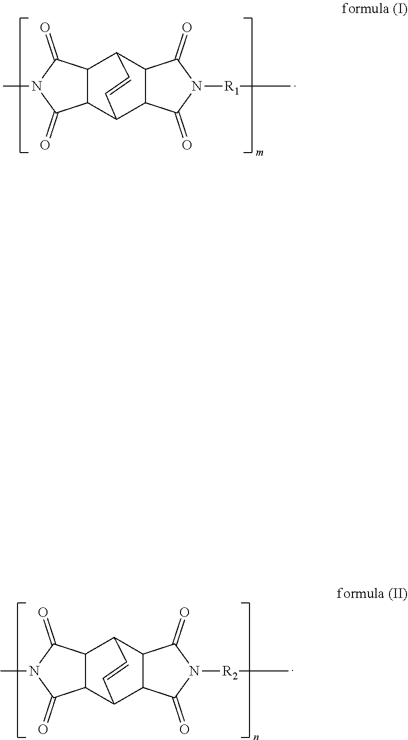

A structural formula of a substituent R₁ is shown as follows:

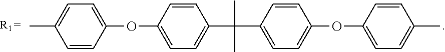

A structural formula of a substituent R₂ is shown as follows:

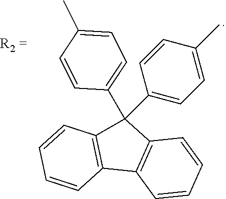 [SMILES: Cc1ccc(C2(c3ccc(C)cc3)c3ccccc3-c3ccccc32)cc1]

In addition, the polyimide copolymer has a weight average molecular weight (Mw) of between 30,000 and 200,000. The polyimide film has a thickness of between 20 micrometers and 40 micrometers.

In certain embodiments, in the polyimide copolymer, m represents a number of repetitions of the plurality of repeating units represented by the formula (I) in the molecular structure of the polyimide copolymer, and n represents a number of repetitions of the plurality of repeating units represented by the formula (II) in the molecular structure of the polyimide copolymer, in which 0.1≤n/(m+n)≤0.6, and 0.4≤m/(m+n)≤0.9.

In certain embodiments, in the polyimide copolymer, 0.2≤n/(m+n)≤0.5, and 0.5≤m/(m+n)≤0.8.

In certain embodiments, in the polyimide copolymer, R₁ is a residue other than two amino groups (—NH₂) in a first aromatic diamine compound, and the first aromatic diamine compound is 1,1-bis[4-(5-amino-2-pyridyloxy)phenyl]-1-phenylmethane (BAPPm). R₂ is a residue other than two amino groups (—NH₂) in a second aromatic diamine compound, and the second aromatic diamine compound is 9,9-bis(4-aminophenyl)-fluorene (FDA).

In certain embodiments, the polyimide copolymer is formed by performing a poly-condensation reaction between the first aromatic diamine compound (BAPPm) and an alicyclic dianhydride compound, and performing a poly-condensation reaction between the second aromatic diamine compound (FDA) and the alicyclic dianhydride compound. The alicyclic dianhydride compound is bicyclo[2.2.2]oct-7-ene-2,3,5,6-tetracarboxylic dianhydride (B1317).

In certain embodiments, the polyimide film has a transparency of not less than 85%, a pencil hardness of between HB and 2H, a thermal expansion coefficient of not greater than 45 ppm/min, a glass transition temperature (Tg) of not less than 280° C., and a thermal decomposition temperature (Td) of not less than 380° C.

In yet another aspect, the present disclosure provides a manufacturing method of a polyimide film, which includes: mixing a first aromatic diamine compound and a second aromatic diamine compound with a first organic solvent to form a diamine monomer mixture; adding an alicyclic dianhydride compound into the diamine monomer mixture to form a reaction mixture; performing a chemical reaction where the first aromatic diamine compound and the second aromatic diamine compound respectively react with the alicyclic dianhydride compound through two amino groups (—NH2) of each of the first and second aromatic diamine compounds, so as to form a polyimide copolymer; and diluting the polyimide copolymer with a second organic solvent; coating the diluted polyimide copolymer on a substrate; and then performing a baking operation to form a polyimide film;

A structural formula of the alicyclic dianhydride compound is shown as follows:

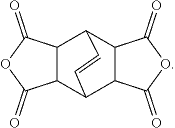 [SMILES: O=C1OC(=O)C2C3C=CC(C12)C1C(=O)OC(=O)C31]

A structural formula of the first aromatic diamine compound is shown as follows:

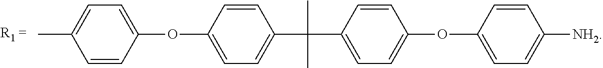 [SMILES: Cc1ccc(Oc2ccc(C(C)(C)c3ccc(Oc4ccc(N)cc4)cc3)cc2)cc1]

A structural formula of the second aromatic diamine compound is shown as follows:

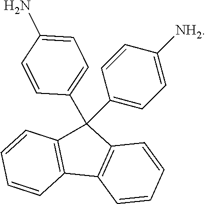 [SMILES: Nc1ccc(C2(c3ccc(N)cc3)c3ccccc3-c3ccccc32)cc1]

In addition, the polyimide copolymer has a weight average molecular weight (Mw) of between 30,000 and 200,000.

In certain embodiments, the first organic solvent is gamma-butyrolactone (GBL), and the second organic solvent is at least one of N,N-dimethylacetamide (DMAc), hexa-methyl-phosphor-amide (HMPA), N-methyl-2-pyrrolidone (NMP), 1,3-dimethyl imidazolinone (DMI) and m-cresol.

In certain embodiments, the reaction mixture further includes a catalyst, and the catalyst is isoquinoline.

In certain embodiments, a content range of solid components in the reaction mixture is between 20 wt % and 40 wt %. Further, the reaction conditions of the chemical reaction include reacting the reaction mixture at a reaction temperature ranging from 35° C. to 45° C. for 0.5 hours to 1.5 hours; and then reacting the reaction mixture at another reaction temperature ranging from 190° C. to 210° C. for 2.5 hours to 3.5 hours.

Therefore, in the polyimide copolymer, the polyimide film, and the manufacturing method thereof provided by the present disclosure, by virtue of “the polyimide copolymer including a plurality of repeating units represented by the formula (I) and a plurality of repeating units represented by the formula (II), and the plurality of repeating units represented by the formula (I) and the plurality of repeating units represented by the formula (II) being configured in a block arrangement or a random arrangement,” the polyimide film can have high transparency, hardness, flexibility, and toughness at the same time.

These and other aspects of the present disclosure will become apparent from the following description of the embodiment, although variations and modifications therein may be affected without departing from the spirit and scope of the novel concepts of the disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

In order to describe a specific numerical range, the term “a certain value to another value” is used in this specification, which should be interpreted as covering any arbitrary value within the specific numerical range and a smaller numerical range defined by any two arbitrary values within the specific numerical range as if the arbitrary values and the smaller numerical range are explicitly listed. In addition, for the sake of brevity, the structural formula of each polymer or functional group in this specification is sometimes expressed in a skeleton formula. Carbon atoms, hydrogen atoms, and carbon-hydrogen bonds in the actual structural formula are omitted. However, when a specific atom or atomic group is clearly depicted in the structural formula, such a structural formula is preferably referred to.

### Polyimide Copolymer

According to an embodiment of the present disclosure, a polyimide copolymer is provided, which is suitable for being formed as a polyimide film (PI film). A chemical structure of the polyimide copolymer includes a plurality of repeating units represented by a following formula (I) and a plurality of repeating units represented by a following formula (II). The plurality of repeating units represented by the following formula (I) and the plurality of repeating units represented by the following formula (II) are configured in a block arrangement or a random arrangement. That is, the polyimide copolymer is a block copolymer or a random copolymer.

The repeating units represented by the formula (I) are as follows:

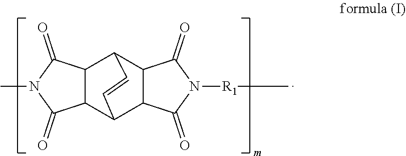

in which a structural formula of a substituent R₁ is shown as follows:

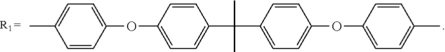

More specifically, R₁ is a residue other than two amino groups (—NH₂) in a first aromatic diamine compound. The first aromatic diamine compound is 1,1-bis[4-(5-amino-2-pyridyloxy)phenyl]-1-phenylmethane (BAPPm). The first aromatic diamine compound has a long-chain structure, which can be used to increase flexibility and toughness of a film material.

The repeating units represented by the formula (II) are as follows:

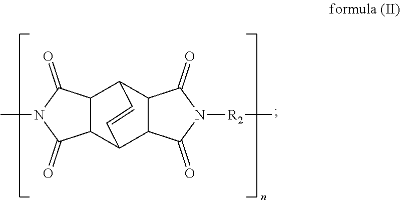

in which a structural formula of a substituent R₂ is shown as follows:

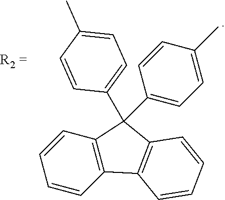 [SMILES: Cc1ccc(C2(c3ccc(C)cc3)c3ccccc3-c3ccccc32)cc1]

More specifically, R₂ is a residue other than two amino groups (—NH₂) in a second aromatic diamine compound. The second aromatic diamine compound is 9,9-bis(4-aminophenyl)-fluorene (FDA). A molecular structure of the second aromatic diamine compound has a steric obstacle. In other words, the molecular structure of the second aromatic diamine compound is relatively rigid, which can be used to increase hardness and rigidity of the film material.

In the present embodiment, the polyimide copolymer has a weight average molecular weight (Mw) of between 30,000 and 200,000.

It should be noted that the term “residue” as used herein refers to a group or a unit derived from a specific compound in a product of a chemical reaction, such as a group derived from an aromatic diamine compound in the polyimide copolymer synthesized through a condensation reaction and a dehydration reaction.

In the embodiment of the present disclosure, the repeating units represented by the formula (I) may be represented by A, and the repeating units represented by the formula (II) may be represented by B.

It should be understood by those skilled in the art that, a random copolymer indicates that the two repeating units A and B in the copolymer appear randomly, and a quantity of each of the repeating units A and B is generally within a range from a few to a dozen or more. In addition, a block copolymer is composed of longer segments with only the repeating units A and longer segments with only the repeating units B, each of which can reach hundreds to thousands of structural units.

In the present embodiment, the polyimide copolymer is formed by performing a polycondensation reaction between the first aromatic diamine compound (BAPPm) and the second aromatic diamine compound (FDA) with an alicyclic dianhydride compound, respectively.

In the present embodiment, the alicyclic dianhydride compound is bicyclo[2.2.2]oct-7-ene-2,3,5,6-tetracarboxylic dianhydride (B1317).

A structural formula of the alicyclic dianhydride compound (B1317) is shown as follows:

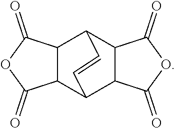 [SMILES: O=C1OC(=O)C2C3C=CC(C12)C1C(=O)OC(=O)C31]

Since the alicyclic dianhydride compound does not have a benzene ring in its molecular structure, using the alicyclic dianhydride compound to synthesize the polyimide copolymer can reduce intramolecular electron transfer. Therefore, compared with a conventional synthesis of polyimide, the use of the alicyclic dianhydride compound in the present embodiment can reduce a synthesis time at a high temperature and reduce a yellowing factor caused by the high temperature, so that a finally produced polyimide film can have a high transparency.

A structural formula of the first aromatic diamine compound (BAPPm) is shown as follows:

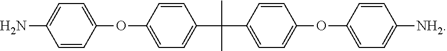 [SMILES: CC(C)(c1ccc(Oc2ccc(N)cc2)cc1)c1ccc(Oc2ccc(N)cc2)cc1]

A structural formula of the second aromatic diamine compound (FDA) is shown as follows:

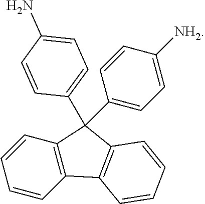 [SMILES: Nc1ccc(C2(c3ccc(N)cc3)c3ccccc3-c3ccccc32)cc1]

In general, since the repeating units represented by the formula (I) have the substituent R₁ (i.e., the residue other than two amino groups in BAPPm), the repeating units represented by the formula (I) can improve the flexibility and toughness of the film material. In addition, since the repeating units represented by the formula (II) have the substituent R₂ (i.e., the residue other than two amino groups in FDA), the repeating units represented by the formula (II) can improve the hardness and rigidity of the film material.

Furthermore, “m” represents a number of repetitions of the plurality of repeating units represented by the formula (I) in the molecular structure of the polyimide copolymer, and “n” represents a number of repetitions of the plurality of repeating units represented by the formula (II) in the molecular structure of the polyimide copolymer, in which “m” ranges from 100 to 1,000, and “n” ranges from 100 to 1000. In terms of numerical ratio, n/(m+n) is between 0.1 and 0.6, and is preferably between 0.2 and 0.5. Furthermore, m/(m+n) is between 0.4 and 0.9, and is preferably between 0.5 and 0.8, but the present disclosure is not limited thereto.

According to the above-mentioned material characteristics, the polyimide film formed from the polyimide copolymer of the embodiment of the present disclosure can have high transparency, hardness, and toughness at the same time.

### Manufacturing Method of Polyimide Copolymer

The above description is related to the material characteristics of the polyimide copolymer of the embodiment of the present disclosure, and a manufacturing method of the polyimide copolymer will be described below according to one embodiment of the present disclosure.

The manufacturing method of the polyimide copolymer includes step S110 to step S130. It should be noted that a sequence of steps and an actual operation described in the present embodiment can be adjusted according to practical requirements, and the present disclosure is not limited to those described in the present embodiment.

The step S110 includes: mixing a first aromatic diamine compound (BAPPm) and a second aromatic diamine compound (FDA) with a first organic solvent to enable the first aromatic diamine compound and the second aromatic diamine compound to be completely dissolved in the first organic solvent, so as to form a diamine monomer mixture. In the present embodiment, the first organic solvent is gamma-butyrolactone (GBL), but the present disclosure is not limited thereto.

The step S120 includes: adding an alicyclic dianhydride compound (B1317) into the diamine monomer mixture prepared in the above step S110 to form a reaction mixture; and then chemically reacting the first aromatic diamine compound (BAPPm) and the second aromatic diamine compound (FDA) with the alicyclic dianhydride compound (B1317) through two amino groups (—NH₂) of each of the first and second aromatic diamine compounds (BAPPm and FDA), respectively, so as to form a polyimide copolymer. The chemical reaction sequentially includes a condensation reaction and a dehydration reaction.

In the step S120, a total number of moles of the first and second aromatic diamine compounds (BAPPm and FDA) compared to a total number of moles of the alicyclic dianhydride compound (B1317) is preferably between 1:0.98 and 1:1.04, and is more preferably 1:1.02, but the present disclosure is not limited thereto. In addition, a number of moles of the first aromatic diamine compound (BAPPm) compared to a number of moles of the second aromatic diamine compound (FDA) is preferably 0.004 to 0.009 moles: 0.001 to 0.006 moles, and is more preferably 0.005 to 0.008 moles: 0.002 to 0.005 moles.

In the step S120, the reaction mixture further includes a catalyst to reduce an activation energy of the chemical reaction, thereby increasing a reaction rate of the chemical reaction. In the present embodiment, the catalyst is isoquinoline, which can be used to reduce a reaction temperature required for the chemical reaction.

In the step S120, a content range of solid components (i.e., monomer compounds and catalysts) in the reaction mixture is preferably between 20 wt % and 40 wt %, and is more preferably between 25 wt % and 35 wt %. Reaction conditions of the chemical reaction include: reacting the reaction mixture at a reaction temperature ranging from 35° C. to 45° C. for 0.5 hours to 1.5 hours; then, reacting the reaction mixture at another reaction temperature ranging from 190° C. to 210° C. for 2.5 hours to 3.5 hours.

In the step S120, the reaction mixture is first formed into a polyimide solution through the condensation reaction, and the polyimide solution is then formed into the polyimide copolymer through the dehydration reaction.

The step S130 includes: cooling the polyimide copolymer prepared in the above step S120 (i.e., cooling to a room temperature); and adding a second organic solvent into the polyimide copolymer for dilution, so as to form a polyimide copolymer solution.

In the step S130, the second organic solvent can be, for example, N,N-dimethylacetamide (DMAc), but the present disclosure is not limited thereto. The second organic solvent can also be, for example, at least one of hexa-methyl-phosphor-amide (HMPA), N-methyl-2-pyrrolidone (NMP), 1,3-dimethyl imidazolinone (DMI) and m-cresol.

The step S130 further includes: pouring an alcohol solvent into the polyimide copolymer solution to precipitate the solid components in the polyimide copolymer solution that are hardly soluble or insoluble in the alcohol solvent; and then filtering the solid components by means of filtration. In the present embodiment, the alcohol solvent is methanol, but the present disclosure is not limited thereto.

It is worth mentioning that the above chemical reaction for forming the polyimide copolymer can be completed by the following chemical reaction formulas (a-1) and (a-2).

The formula (a-1) represents a step of adding various reactive monomers.

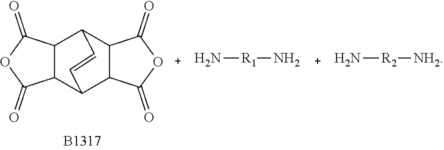

The formula (a-2) represents a formation of a copolymer under an action of a catalyst (i.e., isoquinoline).

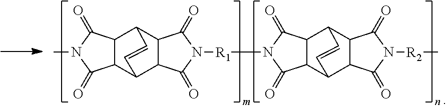

R₁ is the residue other than two amino groups (—NH₂) in the above-mentioned first aromatic diamine compound, and the above-mentioned first aromatic diamine compound is 1,1-bis[4-(5-amino-2-pyridyloxy)phenyl]-1-phenylmethane (BAPPm).

R₂ is the residue other than two amino groups (—NH₂) in the above-mentioned second aromatic diamine compound, and the above-mentioned second aromatic diamine compound is 9,9-bis(4-aminophenyl)-fluorene (FDA).

Further, n/(m+n) is between 0.1 and 0.6, and is preferably between 0.2 and 0.5. Furthermore, m/(m+n) is between 0.4 and 0.9, and is preferably between 0.5 and 0.8, but the present disclosure is not limited thereto.

### Manufacturing Method of Polyimide Film

The above description is related to the manufacturing method of the polyimide copolymer according to the embodiment of the present disclosure, and a manufacturing method of a polyimide film will be described below according to one embodiment of the present disclosure.

The manufacturing method of the polyimide film includes step S210 and step S220. It should be noted that a sequence of steps and an actual operation described in the present embodiment can be adjusted according to practical requirements, and the present disclosure is not limited to those described in the present embodiment.

The step S210 includes: coating the polyimide copolymer solution prepared in the step S130 on a substrate through a coating process. The coating process can be, for example, a knife coating method, a spin coating method, or other suitable coating methods. Furthermore, the substrate can be, for example, a glass substrate or a high temperature resistant plastic substrate, which is not limited by the present disclosure.

The step S220 includes: performing a baking operation to remove liquid components in the polyimide copolymer solution that is coated on the substrate, thereby forming the polyimide film. In the present embodiment, the baking operation sequentially includes: baking the polyimide copolymer solution at a temperature of between 55° C. and 65° C. for 5 minutes to 15 minutes; then, baking the polyimide copolymer solution at a temperature of between 75° C. and 85° C. for 5 minutes to 15 minutes; finally, baking the polyimide copolymer solution at a temperature of between 200° C. and 220° C. for 25 minutes to 35 minutes, but the present disclosure is not limited thereto.

The step S220 further includes: separating the polyimide film from the substrate.

According to the above manufacturing method, the polyimide film has a thickness of between 20 micrometers and 40 micrometers, and preferably between 25 micrometers and 35 micrometers.

Furthermore, the polyimide film has a transparency of not less than 85%, and preferably not less than 88%. The polyimide film has a pencil hardness of between HB and 2H, and preferably between HB and 1H. The polyimide film has a thermal expansion coefficient of not greater than 45 ppm/min. The polyimide film has a glass transition temperature (Tg) of not less than 280° C., and preferably not less than 300° C. The polyimide film has a thermal decomposition temperature (Td) of not less than 380° C., and preferably not less than 400° C.

### Experimental Data and Test Results

Hereinafter, a more detailed description will be provided with reference to Exemplary Examples 1 and 2 and Comparative Example 1. However, the following examples are only provided to aid in understanding of the present disclosure, and are not to be construed as limiting the scope of the present disclosure.

The preparation of Exemplary Example 1 includes: using a three-neck round-bottom flask at a room temperature; venting the three-neck round-bottom flask with nitrogen; adding 0.007 moles of BAPPm and 0.003 moles of FDA into the three-neck round-bottom flask to form a reaction mixture; stirring the reaction mixture until the reaction mixture is completely dissolved; adding 0.01 moles of B1317 to the reaction mixture; heating the reaction mixture to up to 200° C. and reacting for 3 hours to form a polyimide copolymer solution whilst removing water in the polyimide copolymer solution; adding methanol to the polyimide copolymer solution, so that the polyimide copolymer solution precipitates into a filamentous polyimide copolymer; placing the filamentous polyimide copolymer into an oven and drying the same for 12 hours; dissolving the filamentous polyimide copolymer into DMAc to form a polyimide coating solution with a solid content of 15 wt % and a viscosity of 6,000 cp to 10,000 cp; coating the polyimide coating solution on a glass; and drying the polyimide coating solution to form a polyimide film.

The preparation of Exemplary Example 2 is substantially the same as that of Exemplary Example 1, and the main difference of Exemplary Example 2 from Exemplary Example 1 is that BAPPm is changed to 0.005 moles and FDA is changed to 0.005 moles.

The preparation of Comparative Example 1 is substantially the same as that of Exemplary Example 1, and the main difference of Comparative Example 1 from Exemplary Example 1 is that BAPPm is changed to 0.003 moles and FDA is changed to 0.007 moles.

Process parameters and conditions of each component are summarized in Table 1 and Table 2 below.

The polyimide films prepared in Exemplary Examples 1-2 and Comparative Example 1 are tested to obtain physical and chemical properties, such as transparency (measured by a haze-transparency measuring meter), pencil hardness (measured by a pencil hardness tester), thermal expansion coefficient (measured by a dynamic mechanical analyzer DMA), glass transition temperature (Tg) (measured by a differential scanning calorimetry DSC), and thermal decomposition temperature (Td) (measured by a differential scanning calorimetry DSC).

Relevant test results are summarized in Table 1, in which experimental conditions and test results of Exemplary Examples and Comparative example are shown.

TABLE 1

| | | Exemplary | Exemplary | Comparative |
|---|---|---|---|---|
| Items | | Example 1 | Example 2 | Example 1 |
| Amount of | Amount of first | 0.007 mol | 0.005 mol | 0.003 mol |
| monomer | aromatic diamine | | | |
| compound | compound BAPPm | | | |
| | (moles) | | | |
| | Amount of second | 0.003 mol | 0.005 mol | 0.007 mol |
| | aromatic diamine | | | |
| | compound FDA | | | |
| | (moles) | | | |
| | Amount of alicyclic | 0.01 mol | 0.01 mol | 0.01 mol |
| | dianhydride | | | |
| | compound B1317 | | | |
| | (moles) | | | |
| Physical | Film thickness | 30 | 30 | 30 |
| and | (micrometers) | | | |
| chemical | Transparency (%) | 90.4 | 90.1 | 89 |
| properties | Pencil hardness (6 B- | 1 HB | 1 H | 1 H |
| | 5 H) | | | |
| | Thermal expansion | 44 | 45 | 48 |
| | coefficient (ppm/min) | | | |
| | Glass transition | 320 | 325 | 330 |
| | temperature Tg (° C.) | | | |
| | Thermal | 410 | 416 | 421 |
| | decomposition | | | |
| | temperature Td (° C.) | | | |

### Discussion of Test Results

In Exemplary Example 1, an added amount of BAPPm is relatively larger, resulting in higher transparency but lower hardness of the polyimide film. In Exemplary Example 2, the added amount of BAPPm is equivalent to an added amount of FDA, resulting in lower transparency but higher hardness of the polyimide film. In Comparative Example 1, when the added amount of FDA is relatively larger, the hardness of the polyimide film does not exhibit much difference, but the transparency thereof is reduced. Therefore, such results indicate that the added amount of FDA is not greater than 50%.

### Beneficial Effects of the Embodiments

In conclusion, in the polyimide copolymer, the polyimide film, and the manufacturing method thereof provided by the present disclosure, by virtue of “the polyimide copolymer including a plurality of repeating units represented by the formula (I) and a plurality of repeating units represented by the formula (II), and the plurality of repeating units represented by the formula (I) and the plurality of repeating units represented by the formula (II) being configured in a block arrangement or a random arrangement,” the polyimide film can have high transparency, hardness, flexibility, and toughness at the same time.

Furthermore, since the alicyclic dianhydride compound of the present embodiment does not have a benzene ring in its molecular structure, using the alicyclic dianhydride compound to synthesize the polyimide copolymer can reduce intramolecular electron transfer. Therefore, compared with a conventional synthesis of polyimide, the use of the alicyclic dianhydride compound in the present embodiment can reduce a synthesis time at a high temperature and reduce a yellowing factor caused by the high temperature, so that the finally produced polyimide film can have a high transparency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polyimide copolymer, comprising:
a plurality of repeating units represented by a following formula (I) and a plurality of repeating units represented by a following formula (II);
wherein the plurality of repeating units represented by the following formula (I) and the plurality of repeating units represented by the following formula (II) are configured in a block arrangement or a random arrangement; 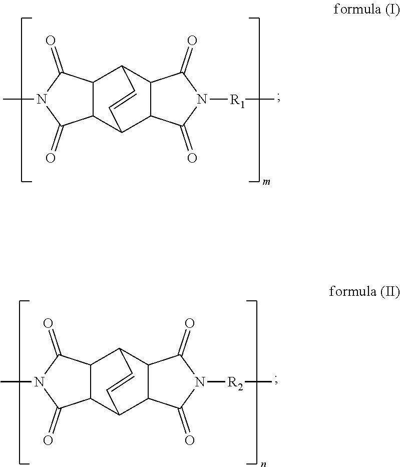
wherein a structural formula of a substituent R₁ is shown as follows: 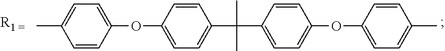
wherein a structural formula of a substituent R₂ is shown as follows: 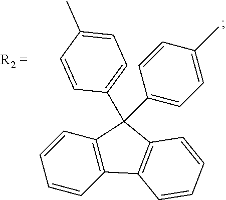 [SMILES: Cc1ccc(C2(c3ccc(C)cc3)c3ccccc3-c3ccccc32)cc1]
wherein the polyimide copolymer has a weight average molecular weight (Mw) of between 30,000 and 200,000.

2. The polyimide copolymer according to claim 1, wherein m represents a number of repetitions of the plurality of repeating units represented by the formula (I) in a molecular structure of the polyimide copolymer, and n represents a number of repetitions of the plurality of repeating units represented by the formula (II) in the molecular structure of the polyimide copolymer; wherein 0.1≤n/(m+n)≤0.6, and 0.4≤m/(m+n)≤0.9.

3. The polyimide copolymer according to claim 2, wherein 0.2≤n/(m+n)≤0.5, and 0.5≤m/(m+n)≤0.8.

4. The polyimide copolymer according to claim 1, wherein R₁ is a residue other than two amino groups (—NH₂) in a first aromatic diamine compound, and the first aromatic diamine compound is 1,1-bis[4-(5-amino-2-pyridyloxy)phenyl]-1-phenylmethane (BAPPm); wherein R₂ is a residue other than two amino groups (—NH₂) in a second aromatic diamine compound, and the second aromatic diamine compound is 9,9-bis(4-aminophenyl)-fluorene (FDA).

5. The polyimide copolymer according to claim 4, wherein the polyimide copolymer is formed by performing a poly-condensation reaction between the first aromatic diamine compound (BAPPm) and an alicyclic dianhydride compound, and performing a poly-condensation reaction between the second aromatic diamine compound (FDA) and the alicyclic dianhydride compound; wherein the alicyclic dianhydride compound is bicyclo[2.2.2]oct-7-ene-2,3,5,6-tetracarboxylic dianhydride (B1317).

6. A polyimide film, characterized in that a composition of the polyimide film includes a polyimide copolymer, and the polyimide copolymer includes a plurality of repeating units represented by a following formula (I) and a plurality of repeating units represented by a following formula (II); wherein the plurality of repeating units represented by the following formula (I) and the plurality of repeating units represented by the following formula (II) are configured in a block arrangement or a random arrangement; 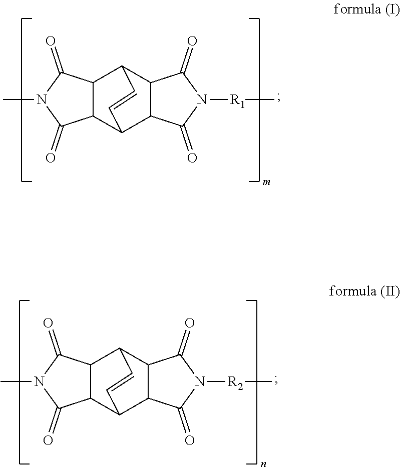
wherein a structural formula of a substituent R₁ is shown as follows: 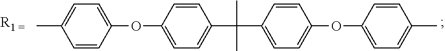
wherein a structural formula of a substituent R₂ is shown as follows: 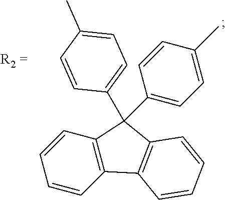 [SMILES: Cc1ccc(C2(c3ccc(C)cc3)c3ccccc3-c3ccccc32)cc1]
wherein the polyimide copolymer has a weight average molecular weight (Mw) of between 30,000 and 200,000, and the polyimide film has a thickness of between 20 micrometers and 40 micrometers.

7. The polyimide film according to claim 6, wherein, in the polyimide copolymer, m represents a number of repetitions of the plurality of repeating units represented by the formula (I) in a molecular structure of the polyimide copolymer, and n represents a number of repetitions of the plurality of repeating units represented by the formula (II) in the molecular structure of the polyimide copolymer; wherein 0.1≤n/(m+n)≤0.6, and 0.4<m/(m+n)≤0.9.

8. The polyimide film according to claim 7, wherein, in the polyimide copolymer, 0.2≤n/(m+n)≤0.5, and 0.5≤m/(m+n)≤0.8.

9. The polyimide film according to claim 6, wherein, in the polyimide copolymer, R₁ is a residue other than two amino groups (—NH₂) in a first aromatic diamine compound, and the first aromatic diamine compound is 1,1-bis[4-(5-amino-2-pyridyloxy)phenyl]-1-phenylmethane (BAPPm); wherein R₂ is a residue other than two amino groups (—NH₂) in a second aromatic diamine compound, and the second aromatic diamine compound is 9,9-bis(4-aminophenyl)-fluorene (FDA).

10. The polyimide film according to claim 9, wherein the polyimide copolymer is formed by performing a poly-condensation reaction between the first aromatic diamine compound (BAPPm) and an alicyclic dianhydride compound, and performing a poly-condensation reaction between the second aromatic diamine compound (FDA) and the alicyclic dianhydride compound; wherein the alicyclic dianhydride compound is bicyclo[2.2.2]oct-7-ene-2,3,5,6-tetracarboxylic dianhydride (B1317).

11. The polyimide film according to claim 6, wherein the polyimide film has a transparency of not less than 85%, a pencil hardness of between HB and 2H, a thermal expansion coefficient of not greater than 45 ppm/min, a glass transition temperature (Tg) of not less than 280° C., and a thermal decomposition temperature (Td) of not less than 380° C.

12. A manufacturing method of a polyimide film, comprising:
mixing a first aromatic diamine compound and a second aromatic diamine compound with a first organic solvent to form a diamine monomer mixture;
adding an alicyclic dianhydride compound into the diamine monomer mixture to form a reaction mixture;
performing a chemical reaction where the first aromatic diamine compound and the second aromatic diamine compound respectively react with the alicyclic dianhydride compound through two amino groups (—NH2) of each of the first and second aromatic diamine compounds, so as to form a polyimide copolymer; and
diluting the polyimide copolymer with a second organic solvent; coating the diluted polyimide copolymer on a substrate; and then performing a baking operation to form the polyimide film;
wherein a structural formula of the alicyclic dianhydride compound is shown as follows: 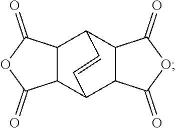 [SMILES: O=C1OC(=O)C2C3C=CC(C12)C1C(=O)OC(=O)C31]
wherein a structural formula of the first aromatic diamine compound is shown as follows: 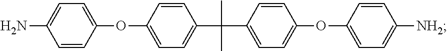 [SMILES: CC(C)(c1ccc(Oc2ccc(N)cc2)cc1)c1ccc(Oc2ccc(N)cc2)cc1]
wherein a structural formula of the second aromatic diamine compound is shown as follows: 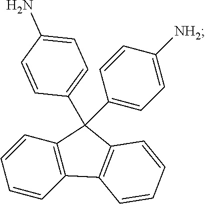 [SMILES: Nc1ccc(C2(c3ccc(N)cc3)c3ccccc3-c3ccccc32)cc1]
wherein the polyimide copolymer has a weight average molecular weight (Mw) of between 30,000 and 200,000.

13. The manufacturing method of the polyimide film according to claim 12, wherein the first organic solvent is gamma-butyrolactone (GBL), and the second organic solvent is at least one of N,N-dimethylacetamide (DMAc), hexa-methyl-phosphor-amide (HMPA), N-methyl-2-pyrrolidone (NMP), 1,3-dimethyl imidazolinone (DMI) and m-cresol.

14. The manufacturing method of the polyimide film according to claim 12, wherein the reaction mixture further includes a catalyst, and the catalyst is isoquinoline.

15. The manufacturing method of the polyimide film according to claim 14, wherein a content range of solid components in the reaction mixture is between 20 wt % and 40 wt %; wherein reaction conditions of the chemical reaction include: reacting the reaction mixture at a reaction temperature ranging from 35° C. to 45° C. for 0.5 hours to 1.5 hours, and then reacting the reaction mixture at another reaction temperature ranging from 190° C. to 210° C. for 2.5 hours to 3.5 hours.
